(19) United States
(12) Patent Application Publication
(10) Pub. No.: US 2006/0231105 A1
(43) Pub. Date: Oct. 19, 2006

(54) Dental operating support

(76) Inventor: Hans F. Levy, Naples, FL (US)

Correspondence Address: Hans F. Levy;#2101, 7425 Pelican Bay Blvd., Naples, FL, 34108, US

(21) Appl. No.: 11/108,541

(22) Filed: Apr. 19, 2005

(51) Int. Cl. A61G 15/00

(52) U.S. Cl. 128/845

(57) ABSTRACT

A chin support adapted to be used on a patient undergoing a prolonged dental procedure. The chin support consists of a bib which is draped around a frontal area of a patient. The bib is made of a relatively stiff material and has two vertical slots therein. A clamping mechanism is located in each of the slots and each has an upstanding rod attached to it. Each of the upstanding rods is attached to a chin support. When a predetermined position has been reached with the chin support with respect to an open jaw of the patient, each of the clamping mechanisms is tightened to keep the chin support in an adjusted position to enhance and maintain the comfort of the patient.

### FIELD OF THE INVENTION

The invention pertains to dentistry, especially, when a dentist has to undertake a procedure that is very time consuming.

### BACKGROUND OF THE INVENTION

During prolonged dental procedures a dental patient has to keep his/her mouth open for a prolonged period of time. The only way to do this is to drop and keep the lower jaw in a certain lowered position so that the dentist can perform his work. This can be very tiring on the muscles of the jaw as well as on the patient. A search has been undertaken to find out if there are any supports that are available to a dentist as well as to a patient to support the lower jaw as well as the chin of the patient to relieve the tiring of the jaw muscles syndrome of the patient while he or she is subjected to a prolonged dental procedure. None have been found.

### BRIEF SUMMARY OF THE INVENTION

The invention solves the above noted problems by providing a simple and inexpensive support system that will support the lower chin, and thereby the lower jaw, while the patient is undergoing a prolonged dental procedure while the mouth of the patient has to stay open for a prolonged period of time. The inventive concept consists of a bib that is draped over the patient's body, especially, the front or the chest area, The bib has slots therein supporting at least two support rods that are adjustable relative to the bib and relative to height. The two support rods are attached to a cushion that is placed under the chin of the patient. The cushion will support the open jaw of the patient at a certain adjusted position even though the dentist is applying pressure to the teeth or the jaw bone of the patient.

### BRIEF DESCRIPTION OF THE DRAWINGS

FIG. 1 is a frontal view of the chin support;

FIG. 2 is a side view of the chin support;

FIG. 3 is a cross section through the clamping mechanism.

FIG. 4 is a different embodiment than the one shown in FIG. 1.

### DETAILED DESCRIPTION OF THE INVENTION

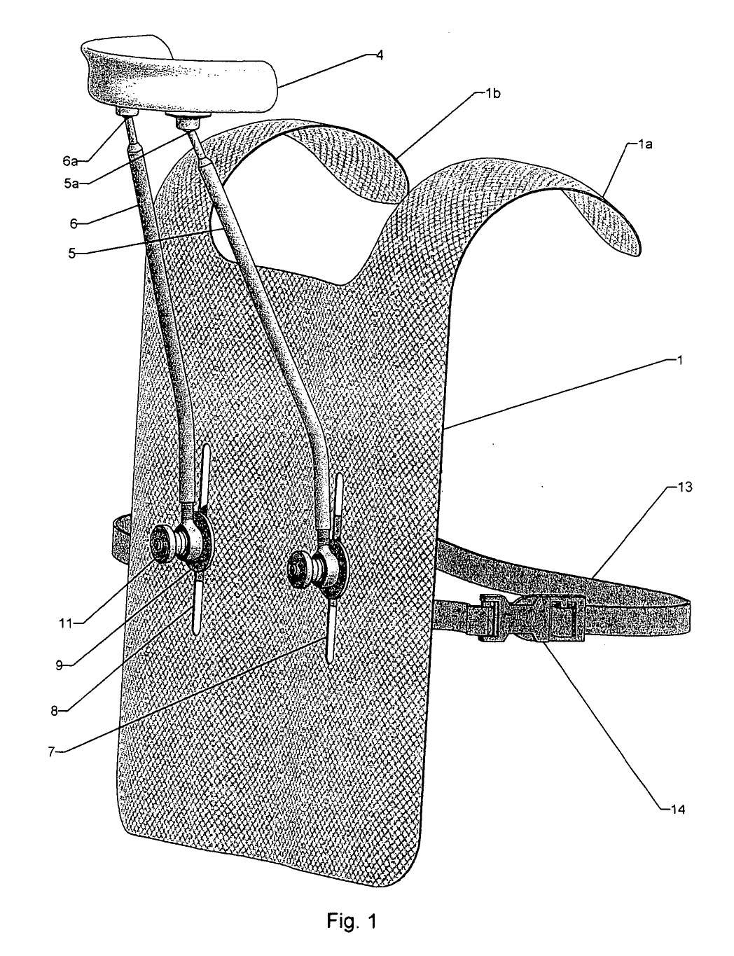

FIG. 1 shows the bib 1 as it is draped on the front area of a patient and over the shoulders of the patient. The ends 1a and 1b of bib, after they have been draped over the shoulders of the patient, could have weights thereon to keep them in place or they could be fastened to each other around the neck of the patient through the use of hook and loop fasteners. The bib should be constructed of a relative stiff material so that it will keep its shape and support the clamping mechanism as will be explained below. 2 illustrates the neck of the patient while 3 shows the chin. At 4 is shown a chin support in the form of a cushion which may be formed to conform to the chin of the patient. The chin support or cushion is attached to bib by way of two support rods 5 and 6. The upper ends of the rods should be embedded in the chin cushion 4 by way of balls or other implements so that they will be self-adjusting when the chin support is fitted to a patient. The bib itself has two vertical slots 7 and 8 therein which will each accommodate a clamping mechanism. The clamping mechanism in each of the slots consists of a washer 9 which overlies the front of the bib and is large enough to slide thereon when adjustments are. Each of the rods 5 and 6 are attached to the washer 9. The washer 9 is clamped to the bib by way of a threaded stud 10 which has a flat head 12 located against the back of the bib. The threaded rod passes through the washer 9 and receives an adjusting knob 11 at its open end. The threaded rods also receive eye adapters 5a and 6b at the bottom of the support rods 6 and 7. It can now be seen that when the washer 9, including the threaded rod 10, is moved to a certain position on the bib, the rods 5 or 6 must follow the movement to thereby ultimately adjust the chin support or cushion in a desired or predetermined position by tightening the adjusting knobs 11 against the washer 9. It also should be noted that the reason why the upper ends 5a and 6a of the rods 5 and 6 should be imbedded in the chin cushion 4 by way of balls, so that the chin support will not always be adjusted symmetrically relative to the bib 1 because it depends on the body stature of the patients.

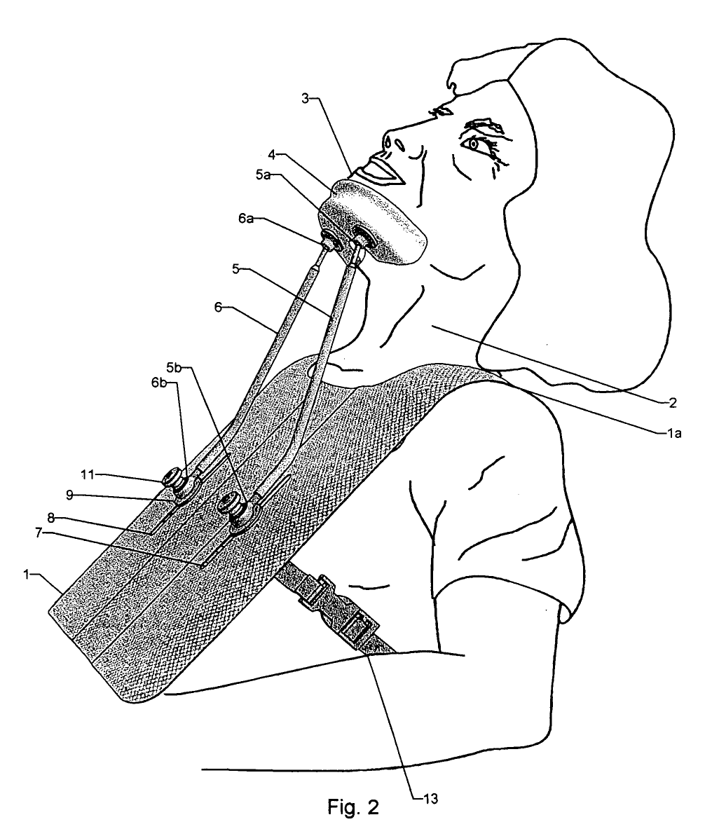

Also shown in FIGS. 1 and 2 are body straps 13 which wrap around the upper torso of a patient to hold the support bib 1 in place. The body strap 13 can be adjusted by way of a buckle 14 or other fastening means such as loop and hook fasteners or adhesive patches.

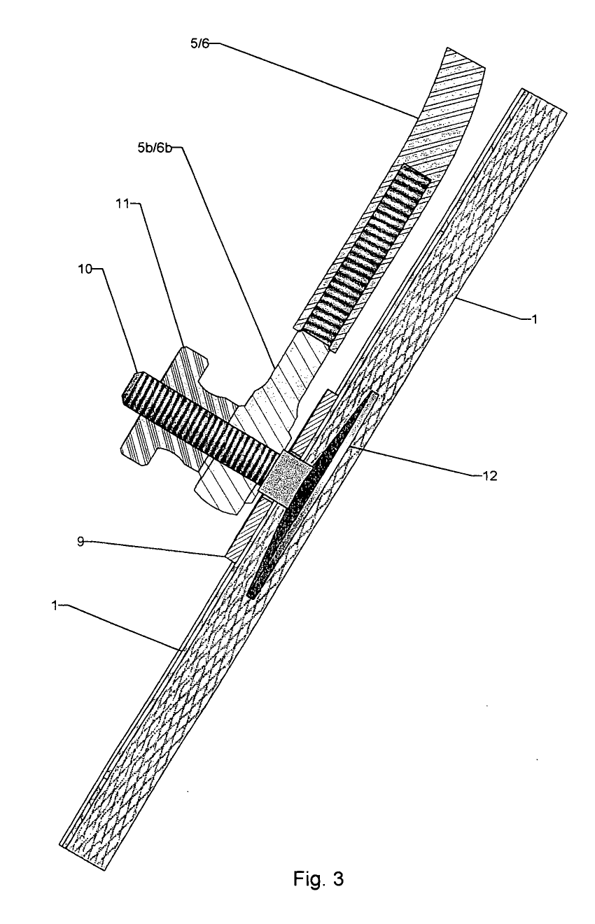

FIG. 3 is a cross section through the clamping bolts 10 to more clearly show the fine adjustments that can be made once the bib 1 is in use and is being adjusted and fitted to a patient. The same reference characters are being used and displayed as were in explaining FIGS. 1 and 2.

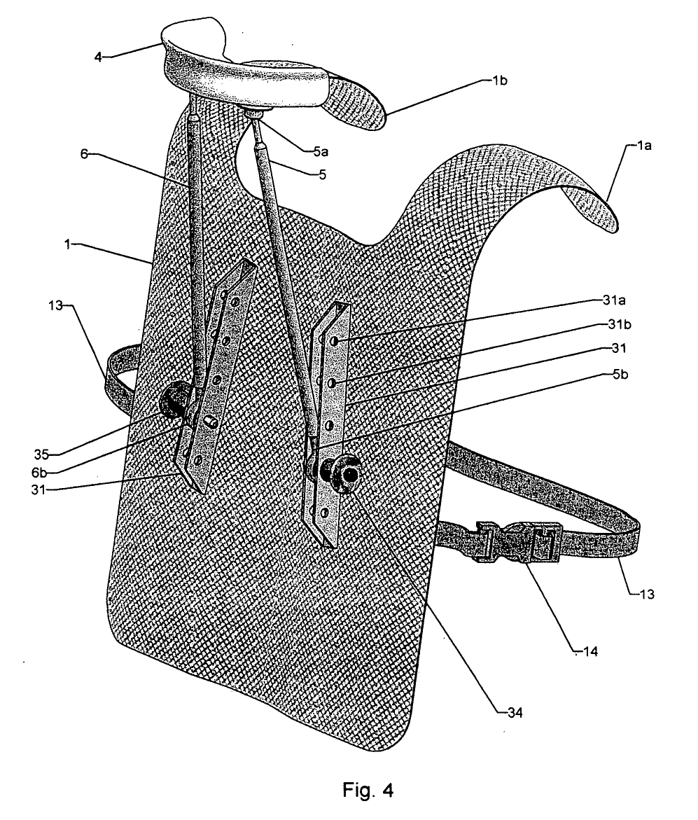

FIG. 4 shows a different embodiment for adjusting the support rods 5 and 6 to support a chin of a wearer. In this respect, instead of using slots in the bib, this embodiment uses rigid stays 3. The stays can be L-shaped or U-shaped as is shown in FIG. 4. The stay 31 have lateral holes 31a and 31b therein which accept lateral studs therein (like 10 in previous Figs.) and which receive the eyes 5b and 6b thereon which eyes are attached to the lower ends of the support rods 5 and 6. All other reference characters in FIG. 4 have been discussed in the FIGS. 1-3 above.

In operation, the bib 1 is placed on the patient by fastening the lower straps 13 around the patient and if desired, by placing the shoulder straps around the neck of the patient. Both adjusting knobs 11 remain loose and the chin support or cushion is moved against the opened jaw of the patient to a comfortable position. Thereafter, the adjusting knobs 11 will be tightened and the cushion 4 is fixed against the jaw. It can now be seen that the dentist may perform the necessary procedure regardless how much time is involved without imparting any muscle fatigue to the jaw and without imparting any discomfort to the patient.

What I claim is:

1. A chin support adapted to be used on a patient while undergoing a prolonged dental procedure, said chin support comprising a bib to be draped over a frontal area of a patient, said bib having two spaced apart vertical slots therein, a clamping mechanism located in each of said slots, each of said clamping mechanisms having upstanding rods attached thereto, each of said rods being attached to a chin support located under a jaw of said patient, means for tightening said clamping mechanism when a desired position is reached with respect of said chin support relative to an open jaw of said patient.

2. The chin support of claim 1, wherein each of said rods is movably imbedded within said chin support.

3. The chin support of claim 1, wherein each of said clamping mechanisms includes an adjusting knob on a threaded stud.

4. The chin support of claim 1, wherein said chin support is a cushion.

5. The chin support of claim 1, wherein said bib is made of a relatively stiff material.

6. The chin support of claim 1 including straps at a lower end of said bib which surround the body of said patient.

7. A chin support adapted to be used on a patient while undergoing a prolonged dental procedure, said chin support comprising a bib to be draped over a frontal area of a patient, said bib having two upstanding spaced apart and vertical rigid stays thereon, said vertical stays having a multiple of vertically spaced apart lateral holes therein, said holes at any location receive at least one threaded bolt there through, said threaded bolt receiving an eye adapter thereon, said eye adapter is each attached to lower ends of vertically extending support rods, said upstanding rods are attached to a chin support which supports a patient's chin, means for clamping said eye adapters to said rigid stays.

8. The chin support of claim 7, wherein said rigid stays are L-shaped.

9. The chin support of claim 7, wherein said rigid stays are U-shaped.
